(19) United States
(12) Patent Application Publication
(10) Pub. No.: US 2023/0090384 A1
(43) Pub. Date: Mar. 23, 2023

(54) CALIBRATING A VIRTUAL FORCE SENSOR OF A ROBOT MANIPULATOR

(71) Applicant: Franka Emika GmbH, München (DE)

(72) Inventor: Andreas Spenninger, Karlsfeld (DE)

(21) Appl. No.: 17/784,366

(22) PCT Filed: Dec. 16, 2020
(86) PCT No.: PCT/EP2020/086422

§ 371 Date: Jun. 10, 2022

(30) Foreign Application Priority Data
Dec. 17, 2019 (DE) 10 2019 134 666.5

(51) Int. Cl. B25J 9/16

(52) U.S. Cl. CPC B25J 9/1692; B25J 9/1694; G05B 2219/37537; G05B 2219/39058; G05B 2219/39059; G05B 2219/40586; G05B 2219/40599

(57) ABSTRACT

The invention relates to a method for calibrating a virtual force sensor of a robot manipulator, wherein the following steps are carried out in a plurality of poses: applying an external wrench to the robot manipulator, ascertaining an estimate of the external wrench, ascertaining a first calibration matrix based on the ascertained estimate and a specified external wrench, ascertaining a second calibration matrix by inverting the first calibration matrix, and storing the respective second calibration matrix in a data set of all of the second calibration matrices, thereby assigning each second calibration matrix to the respective pose for which each second calibration matrix was ascertained.

### CROSS-REFERENCE TO RELATED APPLICATIONS

The present application is the U.S. National Phase of PCT/EP2020/086422, filed on 16 Dec. 2020, which claims priority to German Patent Application No. 10 2019 134 666.5, filed on 17 Dec. 2019, the entire contents of which are incorporated herein by reference.

### BACKGROUND

### Field

The invention relates to a method for calibrating a virtual force sensor of a robot manipulator and a robot system with a robot arm and with a control unit for applying this calibration.

### SUMMARY

The object of the invention is to improve the implementation of a virtual force sensor on a robot manipulator or robot arm.

The invention results from the features of the independent claims. Advantageous developments and configurations are the subject matter of the dependent claims.

A first aspect of the invention relates to a method for calibrating a virtual force sensor of a robot manipulator, the virtual force sensor being used to determine an external wrench acting on the robot manipulator based on torques determined by torque sensors in joints of the robot manipulator, wherein the robot manipulator is moved or guided manually in a large number of poses, and in each of the poses the following steps are performed:
applying a given external wrench to the robot manipulator,
ascertaining an estimate of the external wrench based on an inverse or pseudo-inverse of the transpose of the Jacobian matrix applicable to the current pose and based on an external torque vector, wherein the external torque vector is ascertained based on the torques determined by the torque sensors in the robot manipulator joints and base on expected torques acting on the robot manipulator,
ascertaining a respective first calibration matrix based on the determined estimate of the external wrench and based on the specified external wrench,
ascertaining a respective second calibration matrix by inverting the first calibration matrix, the second calibration matrix being used to adjust an external wrench currently determined during subsequent operation, and
storing the respective second calibration matrix in a data set of all of the second calibration matrices with assignment of the respective second calibration matrix to the respective pose for which the respective second calibration matrix was determined.

A pose of the robot manipulator indicates, in particular, the entirety of the positions and the orientations of all members including an end effector, if present, of the robot manipulator. If the complete information about a pose is known, the robot manipulator can be moved into a unique “attitude” by all drives, especially on its joints.

An external wrench indicates forces and/or torques acting on the robot manipulator from the environment and vice versa, the external wrench generally having three components for forces and three components for torques. The specified external wrench is preferably the same across all poses of the robot manipulator, it is namely constant. Alternatively, a different wrench is preferably provided for at least two of the poses, which advantageously also takes into account those poses that would behave at least partially singularly with a constant wrench, namely in at least some of the joints of the robot manipulator connecting the members an external force of the wrench is transmitted linearly through the joint toward the nearest proximal member without creating a torque in the joint. An example of such a singular pose is when all members of the robot manipulator are aligned on a common straight line and the external wrench has only one force vector precisely in the direction of that same common straight line to the base of the robot manipulator.

As this external wrench is applied to the robot manipulator, an estimate of this external wrench is ascertained by the virtual force sensor. This is done with the help of torque sensors arranged, in particular, but not necessarily exclusively, on the joints. The torque sensors on the joints can be selected from the variety of torque sensors known in the prior art. In particular, the torque sensors are mechanical torque sensors, in which a stretching of a flexible, elastic material, for example, in spokes of the respective torque sensor, is detected, it being possible to infer an applied torque from knowledge of the material constants. Furthermore, it is possible, in particular, to measure a current strength present in an electric motor and, from this, to deduce a torque present in the joint. The respective torque in a joint thus detected is typically based on a large number of causes. In the case of a movement of the robot manipulator, a first part of the torque results from the kinematic forces and torques, in particular, the Coriolis acceleration and the centrifugal acceleration. Another part of the measured torque is due to the influence of gravity, independent of the movement of the robot manipulator.

While the torques at the joints are detected directly or indirectly by a measurement by the torque sensors, these lead to the expected torques due to the influence of gravity and kinematically caused forces and torques. That is, depending on the current speed of movement, on the current acceleration of the robot manipulator, and on the mass distribution and the current pose of the robot manipulator (gravity influence), these torques can theoretically be determined at the torque sensors of the robot manipulator as expected torques and be deducted from the measured torques at the respective torque sensors. This is preferably done in a momentum observer, which provides the external torques.

The (pseudo) inverse of the transpose of the Jacobian matrix is required in order to derive an estimate of the specified external wrench with its current reference point based on the external torques determined in this way. The pseudo-inverse (instead of the inverse itself) is necessary, in particular, when the robot manipulator is a redundant manipulator, namely at least two of the joints connecting the members have mutually redundant degrees of freedom. In a redundant robot manipulator, in particular, members of the robot manipulator can be moved without an orientation and/or a position of the end effector of the robot manipulator changing.

The Jacobian matrix basically links the angular velocities at the joints to the translational and rotational velocities at any point, in particular, at a distal end of the robot manipulator. In principle, however, it is irrelevant whether speeds are actually considered; the Jacobian matrix can also be used for the relationship between the torques at the joints and the forces and torques at any given point. The transpose of the Jacobian matrix J, namely J^{T}, correlates the external wrench Fₑₓₜ to the vector of the determined external torques τₑₓₜ as follows:

τₑₓₜ=J^{T}Fₑₓₜ

After rearranging this equation using the (pseudo) inverse of the transpose of J, denoted as (J^{T})^{#}, the following applies to the estimation of the external wrench F_{ext,est} based on the vector of the determined external torques τₑₓₜ:

F_{ext,est}=(J^{T})^{#}τₑₓₜ

The direction and magnitude of the specified external wrenches are known by definition since the known magnitude of the specified external wrenches is also applied. With the above calculation, the estimate of the external wrench in each individual pose of the robot manipulator in which an external wrench is applied is also known. A respective first calibration matrix K₁ is then ascertained based on the determined estimate of the external wrench F_{ext,est} and based on the specified external wrench F_{ext,real}, in particular, by an element-wise inversion of F_{ext,real} by means of the inversion of a diagonal matrix formed with the components of F_{ext,real}, if no couplings between the components of F_{ext,real} and F_{ext,est} are considered:

K₁=F_{ext,est}·(diag(F_{ext,real}))⁻¹

If such couplings are considered or if this equation is over determined by the number of degrees of freedom of the joints, the pseudo inverse of the matrix of the determined estimate of the external wrench can be used in particular, so that F_{ext,real}^{#}=(F_{ext,real}^{T}F_{ext,real})⁻¹F_{ext,real}^{T} applies, and for the first calibration matrix it follows in particular:

K₁=F_{ext,est}(F_{ext,real}^{T}F_{ext,real})⁻¹F_{ext,real}^{T}

The respective second calibration matrix is determined, in particular, by inverting the first calibration matrix analogously to the above inversion, preferably directly by:

K₂=K₁⁻¹

Alternatively preferred, when the inverse of K₁ cannot be uniquely determined, preferably by its pseudo-inverse as:

K₂=(K₁^{T}K₁)⁻¹K₁^{T}

In the extreme case, the first calibration matrix and the second calibration matrix are each scalars. This is particularly the case when only one component of the external wrench is considered, so that the first calibration matrix is determined based on a scalar estimate of the external wrench and based on a specified scalar external wrench. Accordingly, the second calibration matrix is also a scalar single value.

Thereafter, storing of the respective second calibration matrix in a data set of all of the second calibration matrices with assignment of the respective second calibration matrix to the respective pose for which the respective second calibration matrix was determined takes place.

Preferably, the steps of ascertaining an estimate of the external wrench, of ascertaining a respective first calibration matrix, of ascertaining a respective second calibration matrix, and storing the respective second calibration matrix are each carried out by a computing unit. The computing unit is connected, in particular, to the robot manipulator. The computing unit is particularly preferably arranged on the robot manipulator itself, in particular, on a pedestal or a base of the robot manipulator.

It is an advantageous effect of the invention that instead of calibrating each of the torque sensors of the robot manipulator, all of the torque sensors are pose-dependently calibrated in their function as virtual force sensors, taking into account the expected torques on the robot manipulator, and thus all uncertainties in the mass distribution of the robot manipulator, peculiarities of the torque sensors and other effects are all taken into account. The data set of all second calibration matrices thus makes it possible to apply an individual calibration to the virtual force sensor of the robot manipulator for a specific pose of the robot manipulator.

According to an advantageous embodiment, the specified external wrench is applied to the robot manipulator at a distal end of the robot manipulator. An end effector is preferably arranged at the distal end of the robot manipulator. Since contact forces of the robot manipulator, apart from unexpected collisions, typically take place between the end effector and an object from the environment of the robot manipulator, this embodiment advantageously takes this fact into account, so that the calibration takes place, in particular, with regard to a wrench between the end effector at the distal end of the robot manipulator and the environment of the robot manipulator.

According to a further advantageous embodiment, the ascertaining of the first calibration matrix takes place based on the ascertained estimate of the external wrench and based on the specified inverted or pseudo-inverted external wrench. This corresponds to the preferred embodiment explained above using the inverse F_{ext,real}⁻¹ or the pseudo-inverse F_{ext,real}^{#} of the matrix F_{ext,real} of the ascertained estimate of the external wrench. This results in:

K₁=F_{ext,est}⁻¹F_{ext,real}⁻¹ respectively K₁=F_{ext,est}(F_{ext,real}^{T}F_{ext,real})⁻¹F_{ext,real}^{T}

The plurality of poses of the robot manipulator is preferably defined by an equidistant grid of positions for a reference point of the robot manipulator in relation to a ground-fixed coordinate system, whereby, advantageously, all possible positions of the reference point of the robot manipulator (possibly with several poses per grid point for a redundant robot manipulator) are taken into account, wherein, however, also a very high number of grid points must be considered.

According to a further advantageous embodiment, a task is therefore specified for the robot manipulator, the task is analyzed and working points to be traveled through are identified when the task is carried out, wherein the respective poses of the robot manipulator are selected in such a way that one of the working points and a reference point of the robot manipulator match each other in a respective pose. The reference point of the robot manipulator is, in particular, a reference point at the distal end of the robot manipulator, and is, in particular, willfully arranged at the end effector. The reference point is, in particular, connected to the robot manipulator in a body-fixed manner, in particular, to a location on the surface of the robot manipulator, i.e., it does not move relative to this selected location, even when the robot manipulator moves. With this embodiment, the calibration is advantageously specifically tailored to a task to be performed by the robot manipulator and the number of grid points is significantly reduced.

According to a further advantageous embodiment, the robot manipulator is a redundant robot manipulator and the estimate of the external wrench is determined using the pseudo inverse of the transpose of the current Jacobian matrix for the respective pose of the robot manipulator. A redundant robot manipulator has mutually redundant degrees of freedom. This means, in particular, that members of the robot manipulator can move without changing the orientation of a specific member, in particular, of an end effector of the robot manipulator, and/or a position of a specified reference point, in particular, at the distal end of the robot manipulator.

According to a further advantageous embodiment, at least for a subset of the plurality of poses of the robot manipulator, the redundant robot manipulator is moved in its null space over a plurality of poses and a separate first and second calibration matrix is determined and stored for each of the plurality of poses. Changing inaccuracies in the estimation of an external wrench due to a pose change of the robot manipulator in its null space are also advantageously taken into account by this embodiment.

According to an advantageous embodiment, the application of the specified external wrench on the robot manipulator takes place by suspending a load having a specified mass to the robot manipulator. With constant and known gravity, it is very reliably ensured by suspending a load with a specified mass that the external wrench always acts in the same direction with respect to a ground-fixed coordinate system and always with the same strength.

According to a further advantageous embodiment, the specified external wrench is applied to the robot manipulator by connecting a mechanical spring of the robot manipulator to a support in such a way that the mechanical spring is pre-tensioned and exerts a force on the robot manipulator. The mechanical support is preferably arranged on a second manipulator, preferably on an end effector of the second manipulator. By using a spring, any values of a force component of the external wrench can advantageously be specified continuously by stretching the spring over a specific linear range of the spring.

According to an advantageous embodiment, the application of the specified external wrench on the robot manipulator takes place by suspending a load having a specified mass to the robot manipulator. According to this specific embodiment, the torques from the movement of the robot manipulator are accordingly not taken into account in the expected torques, since precisely these torques are to be detected and an estimate of the external wrench is determined from them. Advantageously, according to this embodiment, neither a load with additional mass on the robot manipulator nor the connection to a spring nor the application of other external forces and/or torques is necessary, since only the movement that can be carried out by the robot manipulator itself is used to calibrate the virtual force sensor.

A further aspect of the invention relates to a robot system with a robot arm and with a control unit, the control unit being designed to implement a virtual force sensor on the robot arm, the virtual force sensor being used to determine an external wrench acting on the robot arm and the external wrench being ascertained based on torques determined by torque sensors in joints of the robot arm and based on expected torques acting on the robot arm and based on the inverse or pseudo-inverse of the transpose of the respective pose-dependent current Jacobian matrix, the control unit being designed to apply a pose-dependent calibration function on the currently determined external wrench and to generate the calibration function from the data set generated according to a method of all second calibration matrices by selecting a specific second calibration matrix associated with the respective current pose of the robot arm or by generating an interpolation from at least two specific ones of the second calibration matrices, wherein the respective poses of the at least two specific ones of the second calibration matrices are closest to the respective current pose of the robot arm.

Such a robot system can match the robot manipulator on which the calibration is performed. The calibration, as explained above, can be used again for application on one's own robot manipulator, or can be used on another robot manipulator, for clarification here referred to as “robot system” with “robot arm”.

Advantages and preferred developments of the proposed system result from an analogous and corresponding transfer of the statements made above in conjunction with the proposed method.

Further advantages, features, and details will be apparent from the following description, in which at least one example embodiment is described in detail—with reference to the drawings, if required. Identical, similar, and/or functionally identical parts are provided with identical reference numerals.

### BRIEF DESCRIPTION OF THE DRAWINGS

In the drawings:

FIG. 1 shows a method for calibrating a virtual force sensor of a robot manipulator according to an example embodiment of the invention;

FIG. 2 shows a robot manipulator on which the method according to FIG. 1 is carried out; and

FIG. 3 shows a robot system for using the result of the calibration according to FIG. 1, in accordance with a further example embodiment of the invention.

The illustrations in the figures are schematic and not to scale.

### DETAILED DESCRIPTION

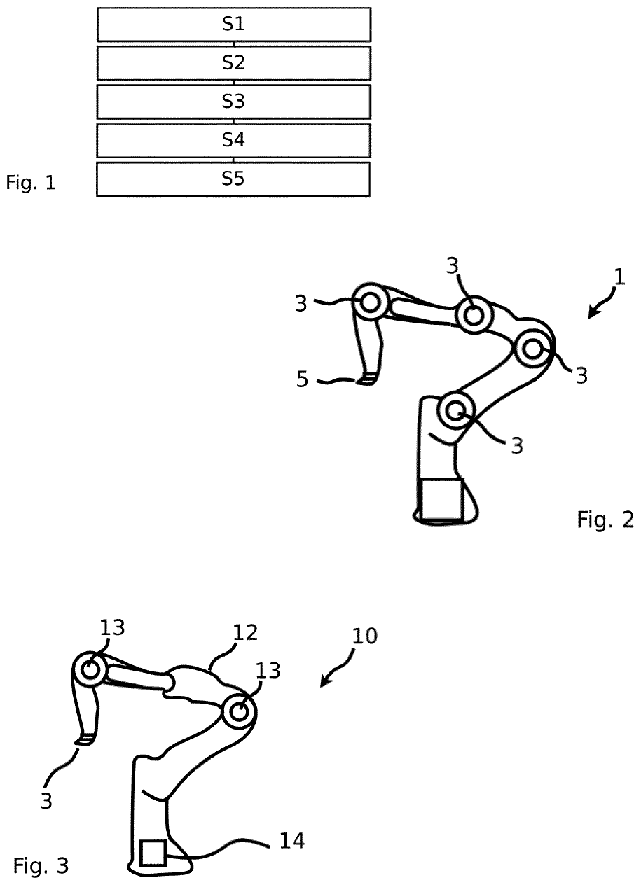

FIG. 1 shows a method for calibrating a virtual force sensor of a robot manipulator 1. The robot manipulator 1 is moved into a large number of poses by appropriately controlling its drives. This is a redundant robot manipulator 1. Therefore, for a common position of the distal end 5 of the robot manipulator 1, a large number of poses of the robot manipulator 1 are assumed by the redundant robot manipulator 1, in that the redundant robot manipulator is moved in its null space over a large number of poses. In each of the poses, the robot manipulator 1 is kept motionless for a certain period of time to perform the following steps repeatedly, namely at each of the poses: initially, at operation S1 a specified external wrench with specified forces and torques is applied to the distal end 5 of the robot manipulator 1. This is done by an external test unit (not shown in FIG. 1). This is followed at operation S2 by ascertaining an estimate of the external wrench F_{ext,est} based on an inverse or pseudo-inverse of the transpose of the Jacobian matrix applicable to the current pose, (J^{T})^{#} and based on an external torque vector, wherein the external torque vector τₑₓₜ is ascertained based on the torques determined by the torque sensors 3 in the joints of the robot manipulator 1 and based on expected torques acting on the robot manipulator 1.

F_{ext,est}=(J^{T})^{#}τₑₓₜ

The pseudo-inverse of the transpose of the Jacobian matrix applicable to the current pose, namely (J^{T})^{#}, is used because a redundant robot manipulator 1 is involved.

This is followed at operation S3 by ascertaining a respective first calibration matrix K₁ based on the determined estimate of the external wrench F_{ext,est} and based on the specified pseudo-inverted external wrench F_{ext,real}, namely:

K₁=F_{ext,est}(F_{ext,real}^{T}F_{ext,real})⁻¹F_{ext,real}^{T}

At operation S4, the ascertaining of a respective second calibration matrix takes place by inverting the first calibration matrix, wherein the second calibration matrix is used to adjust an external wrench currently determined during subsequent operation, and

K₂=(K₁^{T}K₁)⁻¹K₁^{T}

Finally, at operation S5, there takes place storing of the respective second calibration matrix K₂ in a data set of all of the second calibration matrices with assignment of the respective second calibration matrix to the respective pose for which the respective second calibration matrix was determined. Such a robot manipulator 1, on which this method is carried out, is shown in FIG. 2. The reference symbols of FIG. 2 also apply to the above explanation of FIG. 1.

FIG. 2 shows such a robot manipulator 1 with its components, the torque sensors 3 and its distal end 5 of the robot manipulator 1. The redundant degrees of freedom of the robot manipulator 1 are symbolized by a plurality of joints with mutually parallel joint axes. The method as described in FIG. 1 is carried out on this robot manipulator 1. Reference is made to the explanations for FIG. 1.

FIG. 3 shows a robot system 10 with a robot arm 12 and with a control unit 14. The robot system 10 is shown symbolically with a different robot arm 12 in FIG. 3 than the robot manipulator 1 from FIG. 1. This indicates that the calibration according to the explanations for FIG. 1 and FIG. 2 can be transferred to a further robot system 10 without the calibration having taken place thereon. The control unit 14 of the robot system 10 is arranged on a base of the robot arm 12 and implements a virtual force sensor on the robot arm 12, the virtual force sensor being used to determine an external wrench currently acting on the robot arm 12, and the external wrench being ascertained based on torques detected by torque sensors 13 in joints of the robot arm 12 and based on expected torques acting on the robot arm 12 and based on the inverse or pseudo-inverse of the transpose of the respective pose-dependent current Jacobian matrix. The control unit 14 also applies a pose-dependent calibration function to the currently determined external wrench, wherein the calibration function is determined from the data set of all second calibration matrices generated according to the explanations relating to FIG. 1, by selecting a second calibration matrix associated to the current pose of the robot arm 12, namely the closest one.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that many possible variations exist. It is also clear that example embodiments actually only represent examples, which are not to be construed in any way as limiting the scope of protection, the possible applications, or the configuration of the invention. Rather, the preceding description and the description of the figures enable a person skilled in the art to put into practice the example embodiments, wherein a person skilled in the art, knowing the disclosed concept of the invention, can make various changes, for example, with respect to the function or arrangement of individual elements cited in an example embodiment, without leaving the scope of protection as defined by the claims and their legal equivalents, such as more extensive explanations in the description.

### LIST OF REFERENCE NUMERALS

1 robot manipulator
3 torque sensors
5 distal end of the robot manipulator
10 robot system
12 robot arm
13 torque sensors
14 control unit
S1 applying
S2 ascertaining
S3 ascertaining
S4 ascertaining
S5 storing

1. A method of calibrating a virtual force sensor of a robot manipulator, wherein the virtual force sensor is used to determine an external wrench acting on the robot manipulator based on torques determined by torque sensors in joints of the robot manipulator, wherein the robot manipulator (1) is moved or guided manually in a plurality of poses, and in each of the poses the method comprises:
applying a respective specified external wrench to the robot manipulator;
ascertaining an estimate of the external wrench based on an inverse or a pseudo-inverse of a transpose of the Jacobian matrix applicable to a current pose and based on an external torque vector, wherein the external torque vector is ascertained based on the torques determined by the torque sensors in the joints of the robot manipulator and based on expected torques acting on the robot manipulator;
ascertaining a respective first calibration matrix based on the ascertained respective estimate of the external wrench and based on the respective specified external wrench;
ascertaining a respective second calibration matrix by inverting the first calibration matrix, the second calibration matrix being used to adjust an external wrench currently determined during subsequent operation; and
storing the respective second calibration matrix in a data set of all second calibration matrices by assigning the respective second calibration matrix to a respective pose for which the respective second calibration matrix was ascertained.

2. The method according to claim 1, wherein application of the specified external wrench to the robot manipulator takes place at a distal end of the robot manipulator.

3. The method according to claim 1, wherein ascertainment of the first calibration matrix takes place based on the ascertained estimate of the external wrench and based on a specified inverted or pseudo-inverted external wrench.

4. The method according to claim 1, wherein the method comprises:
specifying a task for the robot manipulator;
analyzing the task and identifying working points to be traveled when the task is carried out; and
selecting respective poses of the robot manipulator in such a way that a respective one of the working points and a reference point of the robot manipulator match each other in a respective pose.

5. The method according to claim 1, wherein the robot manipulator is a redundant robot manipulator and the estimate of the external wrench is ascertained using the pseudo inverse of the transpose of the current Jacobian matrix for the respective pose of the robot manipulator.

6. The method according to claim 5, wherein at least for a subset of the plurality of poses of the robot manipulator, the method comprises:
moving the redundant robot manipulator in its null space over a plurality of poses;
determining a separate first calibration matrix and a second calibration matrix; and
storing the first calibration matrix and the second calibration matrix for each of the plurality of poses.

7. The method according to claim 1, wherein application of the specified external wrench on the robot manipulator takes place by suspending a load having a specified mass to the robot manipulator.

8. The method according to claim 1, wherein application of the specified external wrench to the robot manipulator takes place by connecting a mechanical spring of the robot manipulator to a support in such a way that the mechanical spring is pre-tensioned and exerts a force on the robot manipulator.

9. The method according to claim 1, wherein application of the specified external wrench on the robot manipulator takes place by moving the robot manipulator, so that specified accelerations due to inertial mass of the robot manipulator take place on the robot manipulator.

10. The method according to claim 1, wherein the method comprises:
generating a pose-dependent calibration function from the data set of all the second calibration matrices by selecting a specific second calibration matrix associated with a respective current pose of the robot manipulator or by generating an interpolation from at a two specific ones of all the second calibration matrices, wherein respective poses of the at least two specific ones of all the second calibration matrices are closest to the respective current pose of the robot manipulator; and
applying the pose-dependent calibration function on a currently determined external wrench acting on the robot manipulator.

11. A robot system comprising:
a robot manipulator comprising joints;
torque sensors disposed in the joints of the robot manipulator;
a control unit designed to implement a virtual force sensor on the robot manipulator, the virtual force sensor being used to determine an external wrench acting on the robot manipulator based on torques determined by the torque sensors, wherein the robot manipulator is moved or guided manually in a plurality of poses, and in each of the poses the control unit is configured to:
apply a respective specified external wrench to the robot manipulator;
ascertain an estimate of the external wrench based on an inverse or a pseudo-inverse of a transpose of the Jacobian matrix applicable to a current pose and based on an external torque vector, wherein the external torque vector is ascertained based on the torques determined by the torque sensors in the joints of the robot manipulator and based on expected torques acting on the robot manipulator,
ascertain a respective first calibration matrix based on the ascertained estimate of the external wrench and based on the respective specified external wrench;
ascertain a respective second calibration matrix by inverting the first calibration matrix, the second calibration matrix being used to adjust an external wrench currently determined during subsequent operation; and
store the respective second calibration matrix in a data set of all second calibration matrices by assigning the respective second calibration matrix to a respective pose for which the respective second calibration matrix was ascertained.

12. The system according to claim 11, wherein application of the specified external wrench to the robot manipulator takes place at a distal end of the robot manipulator.

13. The system according to claim 11, wherein ascertainment of the first calibration matrix takes place based on the ascertained estimate of the external wrench and based on a specified inverted or pseudo-inverted external wrench.

14. The system according to claim 11, wherein the control unit is configured to:
specify a task for the robot manipulator,
analyze the task and working points to be traveled when the task is carried out; and
select respective poses of the robot manipulator in such a way that a respective one of the working points and a reference point of the robot manipulator match each other in a respective pose.

15. The system according to claim 11, wherein the robot manipulator is a redundant robot manipulator and the estimate of the external wrench is ascertained using the pseudo inverse of the transpose of the current Jacobian matrix for the respective pose of the robot manipulator.

16. The system according to claim 15, wherein at least for a subset of the plurality of poses of the robot manipulator, the control unit is configured to:
move the redundant robot manipulator in its null space over a plurality of poses;
determine a separate first calibration matrix and a second calibration matrix; and
store the first calibration matrix and the second calibration matrix for each of the plurality of poses.

17. The system according to claim 11, wherein application of the specified external wrench on the robot manipulator takes place by suspending a load having a specified mass to the robot manipulator.

18. The system according to claim 1, wherein application of the specified external wrench to the robot manipulator takes place by connecting a mechanical spring of the robot manipulator to a support in such a way that the mechanical spring is pre-tensioned and exerts a force on the robot manipulator.

19. The system according to claim 1, wherein application of the specified external wrench on the robot manipulator takes place by moving the robot manipulator, so that specified accelerations due to inertial mass of the robot manipulator take place on the robot manipulator.

20. The system according to claim 11, wherein the control unit is configured to:
generate a pose-dependent calibration function from the data set of all the second calibration matrices by selecting a specific second calibration matrix associated with a respective current pose of the robot manipulator or by generating an interpolation from at least two specific ones of all the second calibration matrices, wherein respective poses of the at least two specific ones of all the second calibration matrices are closest to the respective current pose of the robot manipulator, and
apply the pose-dependent calibration function on a currently determined external wrench acting on the robot manipulator.
